(19) United States
(12) Patent Application Publication
(10) Pub. No.: US 2023/0370813 A1
(43) Pub. Date: Nov. 16, 2023

(54) DEVICE-FREE IN-ZONE OBJECT MOVEMENT DETECTION USING CHANNEL STATE INFORMATION

(71) Applicant: Cisco Technology, Inc., San Jose, CA (US)

(72) Inventors: Huy Phuong Tran, Santa Clara, CA (US); Nicholas Paul Schnorr, San Jose, CA (US); David A. Maluf, Mountain View, CA (US)

(73) Assignee: Cisco Technology, Inc., San Jose, CA (US)

(21) Appl. No.: 17/742,160

(22) Filed: May 11, 2022

(51) Int. Cl. H04W 4/02; H04W 48/16

(52) U.S. Cl. CPC H04W 4/027; H04W 48/16

(57) ABSTRACT

Object movement detection may be provided. Channel State Information (CSI) data may be obtained. The CSI data may be associated with a plurality of links between a plurality of Access Points (APs) that provide coverage to an area. Next, a plurality of features may be extracted from the CSI data. The plurality of features may then be converted to a plurality of scores. Then motion in sub-areas of the area may be classified based on a comparison of the plurality of scores to a threshold for the area. The threshold may be determined based upon data collected when no motion occurred in the area.

### TECHNICAL FIELD

The present disclosure relates generally to providing object movement detection.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing object movement detection;

FIG. 2 is a flow chart of a method for providing object movement detection;

FIG. 3 illustrates Channel State Information (CSI) data associated with a plurality of links between plurality of APs;

FIG. 4 illustrates a ratio of a first singular value of Singular Value Decomposition (SVD) feature;

FIGS. 5A and 5B illustrate an area being divided into sub-areas; and

FIG. 6 is a block diagram of a computing device.

### DETAILED DESCRIPTION

### Overview

Object movement detection may be provided. Channel State Information (CSI) data may be obtained. The CSI data may be associated with a plurality of links between a plurality of Access Points (APs) that provide coverage to an area. Next, a plurality of features may be extracted from the CSI data. The plurality of features may then be converted to a plurality of scores. Then motion in sub-areas of the area may be classified based on a comparison of the plurality of scores to a threshold for the area. The threshold may be determined based upon data collected when no motion occurred in the area.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Detecting motion in a wireless network may be a desired ability for wireless network providers. Embodiments of the disclosure may provide a process that may generate, for example, a heatmap of object movement in real-time by using Channel State Information (CSI) data measured at Access Points (APs). The heatmap may provide insight, for example, into how people transition within buildings. Using the heatmap, embodiments of the disclosure may locate the movement of objects in different zones (i.e., sub-areas) in an area covered by the APs.

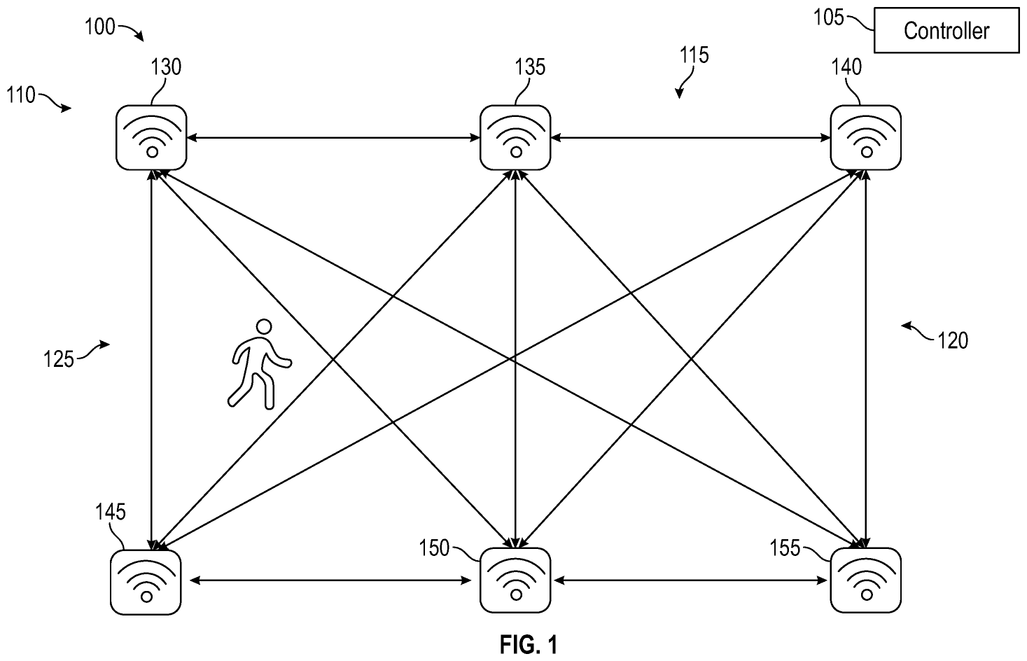

FIG. 1 shows an operating environment 100 for providing object movement detection. As shown in FIG. 1, operating environment 100 may comprise a controller 105, a coverage environment 110, a plurality of Access Point (APs) 115, a plurality of links 120, and an area 125. Plurality of APs 115 may comprise a first AP 130, a second AP 135, a third AP 140, and a fourth AP 145, a fifth AP 150, and a sixth AP 155. While the example of FIG. 1 illustrates APs, embodiments of the disclosure are not limited to APs and may cover any radio capable of transmitting and receiving a signal.

Coverage environment 110 may comprise, but is not limited to, a Wireless Local Area Network (WLAN) comprising plurality of APs 115. The plurality of APs 115 may provide wireless network access (e.g., access to the WLAN) for client devices. Each of the plurality of APs 115 may be compatible with specification standards such as, but not limited to, the Institute of Electrical and Electronics Engineers (IEEE) 802.11 specification standard for example. Coverage environment 110 may comprise, but is not limited to, an outdoor wireless environment, such as a mesh (e.g., a Wi-Fi mesh). Embodiments of the disclosure may also apply to indoor wireless environments and non-mesh environments.

Ones of client devices served by coverage environment 110 may comprise, but are not limited to, a smart phone, a personal computer, a tablet device, a mobile device, a telephone, a remote control device, a set-top box, a digital video recorder, an Internet-of-Things (IoT) device, a network computer, a router, an Automated Transfer Vehicle (ATV), a drone, an Unmanned Aerial Vehicle (UAV), a Virtual reality (VR)/Augmented reality (AR) device, or other similar microcomputer-based device.

Controller 105 may comprise a Wireless Local Area Network controller (WLC) and may provision and control operating environment 100 (e.g., the WLAN). Controller 105 may allow the client devices to join operating environment 100. In some embodiments of the disclosure, controller 105 may be implemented by a Digital Network Architecture Center (DNAC) controller (i.e., a Software-Defined Network (SDN) controller) that may configure information for operating environment 100 in order to provide object movement detection consistent with embodiments of the disclosure.

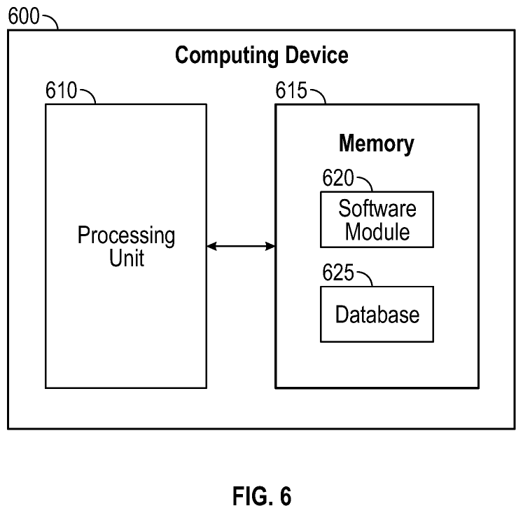

The elements described above of operating environment 100 (e.g., controller 105, the client devices, first AP 130, second AP 135, third AP 140, fourth AP 145, fifth AP 150, and sixth AP 155) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 6, the elements of operating environment 100 may be practiced in a computing device 600.

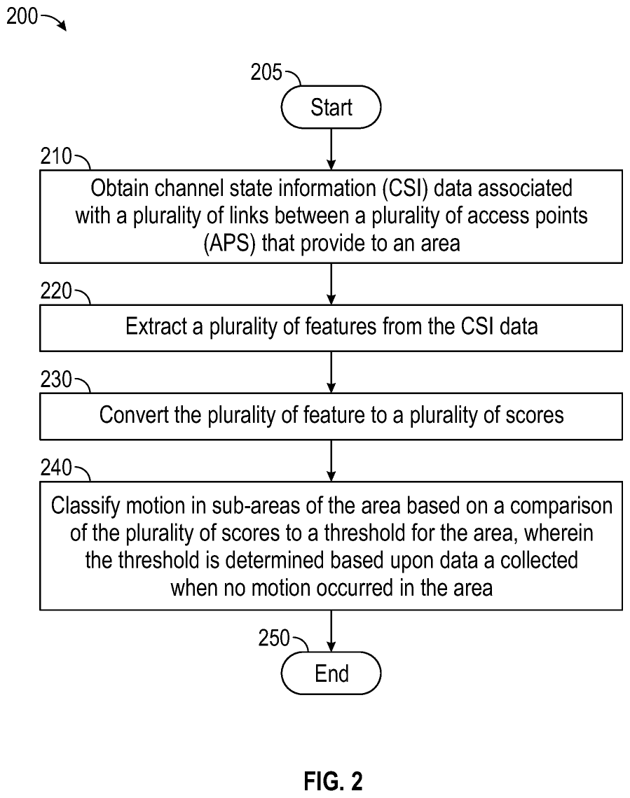

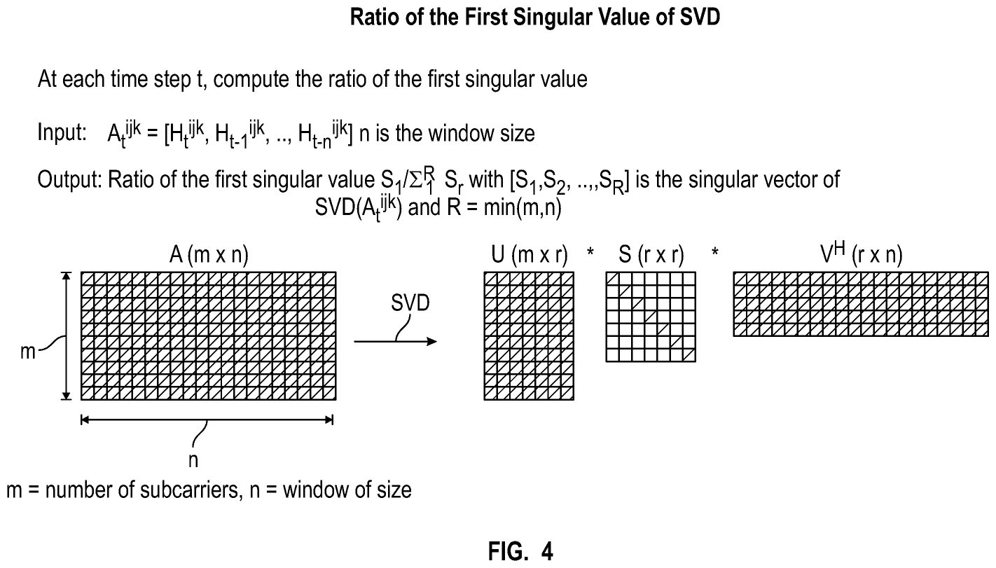

FIG. 2 is a flow chart setting forth the general stages involved in a method 200 consistent with an embodiment of the disclosure for providing object movement detection. Method 200 may be implemented using controller 105 that may be embodied by a computing device 600 as described in more detail below with respect to FIG. 4. Ways to implement the stages of method 200 will be described in greater detail below.

Method 200 may begin at starting block 205 and proceed to stage 210 where controller 105 may obtain Channel State Information (CSI) data associated with plurality of links 120 between plurality of APs 115 that provide coverage to area 125. For example, the CSI data may be obtained during Neighbor Discovery Protocol (NDP) exchanges between plurality of APs 115 over plurality of links 120 and provided to controller 105.

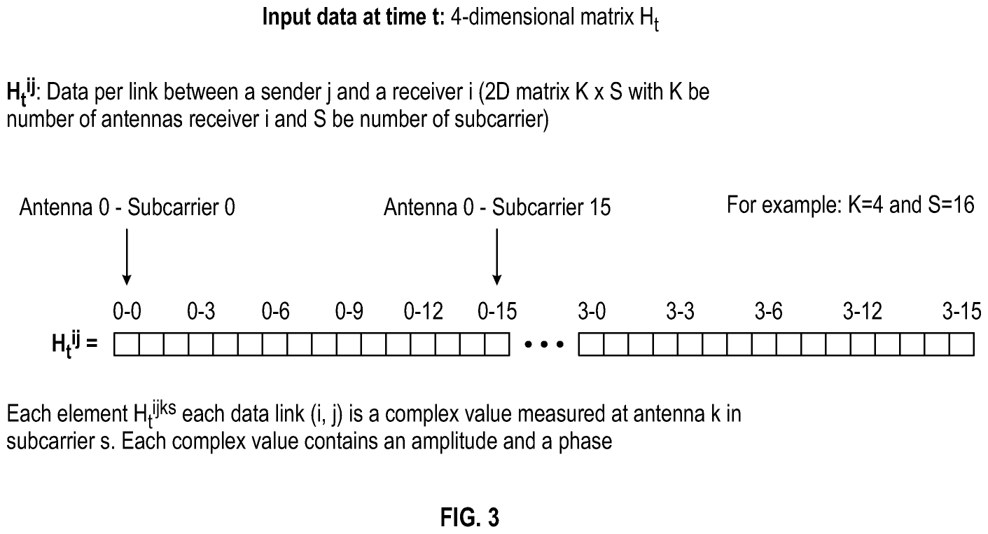

Each of plurality of APs 115 may have a plurality of antenna k (e.g., 4) and each of plurality of links 120 may be divided into a plurality of subcarriers s (e.g., 16). As illustrated by FIG. 3, the CSI data may be placed in a four dimensional matrix Hₜ. Hₜ^{ijks} may comprise data per link (of plurality of links 120) between a sender AP j (of plurality of APs 115) and a receiver AP i (of plurality of APs 115) with k being the number of antennas at receiver i and s be number of subcarriers. Each element Hₜ^{ijks} in each data link (i, j) may comprise a complex value measured at antenna k in subcarrier s. Each complex value may contain an amplitude and a phase. Current CSI data and previous CSI data may be buffered based on a maximum window size and duration as [Hₜ, Hₜ₋₁, Hₜ₋₂, . . . Hₜ₋ₙ].

From stage 210, where controller 105 obtains CSI data associated with plurality of links 120 between plurality of APs 115 that provide coverage to area 125, method 200 may advance to stage 220 where controller 105 may extract a plurality of features from the CSI data. For example, using data from the aforementioned buffered data [Hₜ, Hₜ₋₁, Hₜ₋₂, . . . Hₜ₋ₙ], controller 105 may compute a feature per antenna (of the plurality of APs 115) per data link (of plurality of links 120). Furthermore, controller 105 may smooth the features, calibrate the features, and aggregate the features across antennas in order to have an aggregated feature per data link (of plurality of links 120). The plurality of features may comprise, but not limited to, correlations between consecutive subcarrier vectors per antenna over time, a ratio of a first singular value of Singular Value Decomposition (SVD), or an absolute difference of consecutive variance across subcarriers over time.

Regarding the correlation feature, a correlation may be taken between a subcarrier vector at time t and a subcarrier vector at time t−1. For example, a Pearson correlation between consecutive subcarrier vectors per antenna over time may comprise Correlation (Hₜ^{ijks}, Hₜ₋₁^{ijks}), where Hₜ^{ijks} may comprise a vector of magnitude per subcarrier at antenna k in the data link between receiver AP i and sender AP j at time t. High correlation values may indicate small fluctuation in CSI data across subcarriers over time, which may indicate less effect of motion on a wireless network environment.

Regarding the ratio of the first singular value of Singular Value Decomposition (SVD), at each time step t, the ratio of the first singular value may be computed. As illustrated by FIG. 4, the input may comprise Aₜ^{ijks}=[Hₜ^{ijks}, Hₜ₋₁^{ijks}, . . . , Hₜ₋ₙ^{ijks}](where n is the window size) and the output may comprise the ratio of the first singular value S₁/Σ¹_{R} Sr with [S₁, S₂, . . . , S_{R}] is the singular vector of SVD(Aₜ^{ijks}) and R=min (m, n). High output values may indicate small fluctuation in CSI data across subcarriers over time, which may indicate less effect of motion on the wireless network environment.

Regarding the absolute difference of consecutive variance of CSI amplitude across subcarriers over time, at each time t, a variance may be taken across all subcarriers, subtract t and t−1, and then get an absolute value of the absolute difference of consecutive variance across subcarriers at time t. This may comprise IVAR(Hₜ^{ijks})−VAR(Hₜ₋₁^{ijks})|, where Hₜ^{ijks} may be the magnitude across subcarriers at antenna k in the data link between receiver AP i and sender AP j at time t. Low absolute difference in variance may indicate small fluctuation in CSI data across subcarriers over time, which may indicate less effect of motion on the wireless network environment.

As stated above, the features may be calibrated to improve the quality of the output. Before the start of method 300, CSI data may be collected when area 125 has no moving objects for a short period of time (e.g., several seconds). This may not require intensive human effort as in fingerprint-based approaches, which may require a person to stay at many locations in an environment for some interval. This may be performed again if there is a significant change in the environment settings of area 125. The only requirement may be that there is no object movement for several seconds, which may be safe to be performed at night for example. This calibration process, which may occur in real-time, may first normalizes raw CSI features such as correlation by using an estimated Gaussian distribution of raw CSI features computed when there are no moving objects in area 125. In this way, embodiments of the disclosure may calibrate features per antenna by using a feature distribution when area 125 has no movement. For combining CSI features from multiple data links, embodiments of the disclosure may apply a logistics function to scale these normalized features.

Once controller 105 extracts the plurality of features from the CSI data in stage 220, method 200 may continue to stage 230 where controller 105 may convert the plurality of features to a plurality of scores. For example, as stated above, the features may be aggregated across antennas to create aggregated features per data link (plurality of links 120). Each aggregated feature per data link may be converted to a score. The links may be selected based on zone information and the link scores may be projected on a two-dimensional (2D) image (i.e., a heatmap). Heatmap pixel values may be computed that indicate likelihood of movement at each location (i.e., sub-areas of area 125). In other words, embodiments of the disclosure may combine calibrated CSI features across different data links (of plurality of links 120) in area 125 to generate a 2D heatmap that represents the likelihood of having movement at each sub-areas. This process may comprise the following stages. First, calibrated features may be projected onto a 2D surface (floor). This projection may be an orthogonal projection that may not require any physics model. However, it may be extended to use a physics model to enhance projecting CSI features from 3D to 2D. Next, calibrated features may be normalized in the same cell (i.e., sub-area) in the surface. Then values of cells having no projected features may be interpolated.

After controller 105 converts the plurality of features to the plurality of scores in stage 230, method 200 may proceed to stage 240 where controller 105 may classify motion in sub-areas of area 125 based on a comparison of the plurality of scores to a threshold for area 125. The threshold may be determined based upon data collected when no motion occurred in area 125. For example, a heatmap may be created of area 125 having no movement. Then the threshold may comprise the maximum mean value of the heatmap for example.

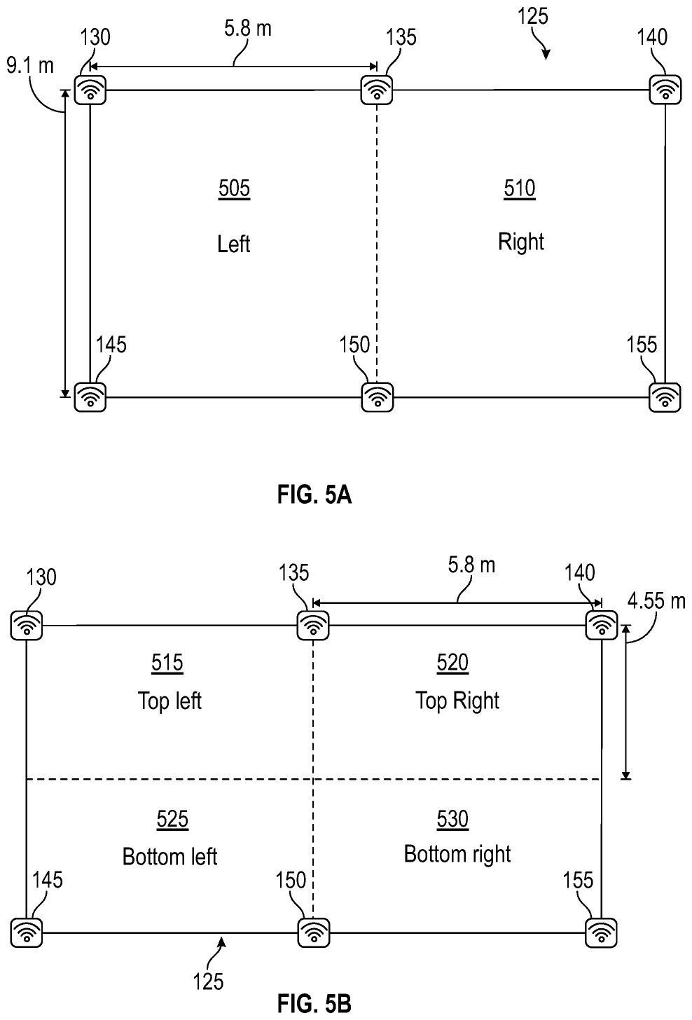

Consistent with embodiments of the disclosure, in-zone (coarse-grain) movement detection processes may divide the generated heatmap of area 125 into smaller heatmaps based on pre-defined zones (i.e., sub-area). Statistics may then be measured of the divided heatmaps to detect if there is movement in each zone (i.e., sub-area). Parameters in this process may be automatically computed using data collected when there are no moving objects in area 125 (e.g., at night or may be confirmed with camera data). FIG. 5A illustrates area 125 divided into a first sub-area 505 and a second sub-area 510. FIG. 5B illustrates area 125 divided into a third sub-area 515, a fourth sub-area 520, a fifth sub-area 525, and a sixth sub-area 530. Once controller 105 classifies motion in sub-areas of area 125 based on the comparison of the plurality of scores to the threshold for area 125 in stage 240, method 200 may then end at stage 250.

FIG. 6 shows computing device 600. As shown in FIG. 6, computing device 600 may include a processing unit 610 and a memory unit 615. Memory unit 615 may include a software module 620 and a database 625. While executing on processing unit 610, software module 620 may perform, for example, processes for providing object movement detection as described above with respect to FIG. 2. Computing device 600, for example, may provide an operating environment for controller 105, the client devices, first AP 130, second AP 135, third AP 140, fourth AP 145, fifth AP 150, and sixth AP 155. Controller 105, the client devices, first AP 130, second AP 135, third AP 140, fourth AP 145, fifth AP 150, and sixth AP 155 may operate in other environments and are not limited to computing device 600.

Computing device 600 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 600 may comprise any computer operating environment, such as hand-held devices, multiprocessor systems, microprocessor-based or programmable sender electronic devices, minicomputers, mainframe computers, and the like. Computing device 600 may also be practiced in distributed computing environments where tasks are performed by remote processing devices. The aforementioned systems and devices are examples, and computing device 600 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 600 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure

1. A method comprising:
obtaining Channel State Information (CSI) data associated with a plurality of links between a plurality of Access Points (APs) that provide coverage to an area;
extracting a plurality of features from the CSI data;
converting the plurality of features to a plurality of scores; and
classifying motion in sub-areas of the area based on a comparison of the plurality of scores to a threshold for the area, wherein the threshold is determined based upon data collected when no motion occurred in the area.

2. The method of claim 1, wherein extracting the plurality of features comprises determining the plurality of features on a per antenna, per link basis.

3. The method of claim 1, wherein extracting the plurality of features comprises smoothing the plurality of features.

4. The method of claim 1, wherein extracting the plurality of features comprises calibrating the plurality of features.

5. The method of claim 1, wherein extracting the plurality of features comprises aggregating the plurality of features across antennas.

6. The method of claim 1, further comprising generating a heatmap, wherein generating the heatmap comprises projecting the plurality of scores on a two-dimensional image.

7. The method of claim 6, wherein the heatmap comprises pixel values that indicate a likelihood of movement at each pixel location.

8. The method of claim 1, wherein obtaining the CSI data comprises obtaining the CSI data during Neighbor Discovery Protocol (NDP) exchanges.

9. The method of claim 1, wherein the plurality of features comprises correlations between consecutive subcarrier vectors per antenna over time.

10. The method of claim 1, wherein the plurality of features comprises a ratio of a first singular value of Singular Value Decomposition (SVD).

11. The method of claim 1, wherein the plurality of features comprises an absolute difference of consecutive variance across subcarriers over time.

12. A system comprising:
a memory storage; and
a processing unit coupled to the memory storage, wherein the processing unit is operative to:
obtain Channel State Information (CSI) data associated with a plurality of links between a plurality of Access Points (APs) that provide coverage to an area;
extract a plurality of features from the CSI data;
convert the plurality of features to a plurality of scores; and
classify motion in sub-areas of the area based on a comparison of the plurality of scores to a threshold for the area, wherein the threshold is determined based upon data collected when no motion occurred in the area.

13. The system of claim 12, wherein the processing unit being operative to extract the plurality of features comprises the processing unit being operative to determine the plurality of features on a per antenna, per link basis.

14. The system of claim 12, wherein the processing unit being operative to extract the plurality of features comprises the processing unit being operative to smooth the plurality of features.

15. The system of claim 12, wherein the processing unit being operative to extract the plurality of features comprises the processing unit being operative to calibrate the plurality of features.

16. The system of claim 12, wherein the processing unit being operative to extract the plurality of features comprises the processing unit being operative to aggregate the plurality of features across antennas.

17. A computer-readable medium that stores a set of instructions which when executed perform a method executed by the set of instructions comprising:
obtaining Channel State Information (CSI) data associated with a plurality of links between a plurality of Access Points (APs) that provide coverage to an area;
extracting a plurality of features from the CSI data;
converting the plurality of features to a plurality of scores; and
classifying motion in sub-areas of the area based on a comparison of the plurality of scores to a threshold for the area, wherein the threshold is determined based upon data collected when no motion occurred in the area.

18. The computer-readable medium of claim 17, wherein the plurality of features comprises correlations between consecutive subcarrier vectors per antenna over time.

19. The computer-readable medium of claim 17, wherein the plurality of features comprises a ratio of a first singular value of Singular Value Decomposition (SVD).

20. The computer-readable medium of claim 17, wherein the plurality of features comprises an absolute difference of consecutive variance across subcarriers over time.
